(19) United States
(12) Patent Application Publication
(10) Pub. No.: US 2018/0309311 A1
(43) Pub. Date: Oct. 25, 2018

(54) COLD-START DEVICE FOR HARVESTING ENERGY

(71) Applicant: INTEL CORPORATION, Santa Clara, CA (US)

(72) Inventors: Christopher SCHAEF, Lebanon, NH (US); Vaibhav VAIDYA, Portland, OR (US); Suhwan KIM, Hillsboro, OR (US); Krishnan RAVICHANDRAN, Saratoga, CA (US)

(21) Appl. No.: 15/495,392

(22) Filed: Apr. 24, 2017

(51) Int. Cl. H02J 7/00; H02M 3/07

(52) U.S. Cl. CPC H02J 7/0068; H02M 3/07

(57) ABSTRACT

An electronic device may include a harvester device to receive an alternative power from an alternative power source. An electronic device may also include a cold-start device to provide an additional power derived from the alternative power source. The harvester device may receive the additional power from the cold-start device, and combine the alternative power and the additional power to at least a specific level.

### BACKGROUND

### 1. Field

Embodiments may relate to a cold-start device for applying an alternative power (or alternative energy) to an electronic device.

### 2. Background

Power availability and battery life are factors that impact a user's experience with an electronic device (or apparatus). Energy harvesting may provide an alternative power source. A device may be used to provide the alternative power to the electronic device (or apparatus).

### BRIEF DESCRIPTION OF THE DRAWINGS

Arrangements and embodiments may be described in detail with reference to the following drawings in which like reference numerals refer to like elements and wherein:

FIG. 1 shows an alternative power source and an electronic device according to an example arrangement;

FIG. 2 shows a cold-start device for powering a load using an alternative power source according to an example embodiment;

FIG. 3 shows a cold-start device for powering a load using an alternative power source according to an example embodiment;

FIG. 4 is circuit diagram of a charge pump according to an example arrangement;

FIG. 5 is a circuit diagram of a harvester device according to an example arrangement;

FIG. 6 is a flow chart showing a two-stage operation for harvesting energy according to an example embodiment;

FIG. 7 shows an electronic device according to an example embodiment; and

FIG. 8 shows an electronic system according to an example embodiment.

### DETAILED DESCRIPTION

In the following description, numerous specific details may be set forth. However, it is understood that embodiments may be practiced without these specific details. In other instances, well-known circuits, structures and techniques may not be shown in detail in order to not obscure an understanding of this description.

References to “one embodiment,” “an embodiment,” “example embodiment,” “various embodiments,” etc., indicate that embodiments may include particular features, structures, or characteristics, but not every embodiment necessarily includes the particular features, structures, or characteristics. Further, some embodiments may have some, all, or none of the features described for other embodiments. Features from one embodiment (or arrangement) may be combined with features of other embodiments (or arrangements).

Embodiments may relate to an electronic device (or apparatus). Examples of an electronic device may include any one of a mobile terminal, a mobile device, a mobile computing platform, a mobile platform, a laptop computer, a tablet, an ultra-mobile personal computer, a mobile Internet device, a smartphone, a personal digital assistant, a display device, a television (TV), and/or etc.

An electronic device may utilize an alternative power source (or a harvested energy) in order to power (and/or charge) the electronic device. However, the alternative power source (or harvested energy) may be an unstable voltage supply and/or a variable power or energy source. That is, an output voltage and power from a harvester (or other device) may vary widely. As one example, an output voltage of a solar panel may range from zero volts (V) to a large open circuit voltage.

Many of the alternative power sources that can be harvested are intermittent and often unpredictable. For example, solar or wind power may not be available in sufficient quantities in order to continuously operate an electronic device when its battery is depleted and the electronic device shuts down.

In a situation in which power at a battery of the electronic device is depleted, the electronic device may have to be powered from an alternative energy (or harvested energy). However, the alternative energy (or harvested energy) may only provide very low voltage levels, and thus the electronic device may not be directly and fully powered from the alternative power sources.

In order to provide a proper voltage to start the electronic device, a cold-start device (or cold-start circuit) may be used to boost a voltage of the alternative power source (or harvested energy) to a sufficient level (or specific level). The cold-start device may be used to re-power the electronic device.

Embodiments may include an electronic device having a cold-start device and a harvester device. The cold-start device may provide an additional power derived from an alternative power source. The harvester device may receive the additional power from the cold-start device and receive an alternative power from an alternative power source. The harvester device may combine the alternative power and the additional power to at least a specific level. Once the combined power (or energy) has reached the specific level, the harvester device may operate in a self-sustained manner (or a self-sustained operation) in order to provide a proper power to a load and/or to a battery.

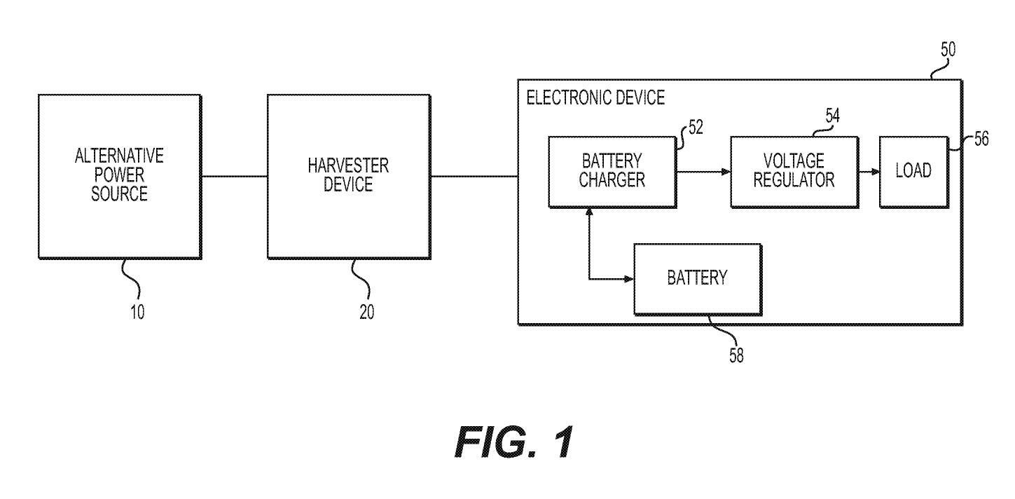

FIG. 1 shows an alternative power source and an electronic device according to an example arrangement. Other arrangements may also be provided.

More specifically, FIG. 1 shows an arrangement in which an electronic device 50 may be powered by an alternative power source 10. The electronic device 50 may be different depending on the type of power source used to power the electronic device. In other words, electrical devices may be powered by specific types of power sources.

A harvester device 20 (or harvester) may be used when the electronic device 50 is to be powered by the alternative power source 10. FIG. 1 shows the harvester device 20 as being external to the electronic device 50. However, the harvester device 20 may be part of the electronic device 50 (i.e., internal). The harvester device 20 may also be referred to as an alternative power processing unit.

The alternative power source 10 may be any one of a solar energy source, a mechanical energy source (such as via wind), a photovoltaic (PV) energy source, a thermal energy source, a radio frequency (RF) energy source, a vibration energy source, a biomechanical energy source, a fuel cell and/or any other power source. Other alternative power sources may also be used.

The alternative power source 10 may provide power (or energy) to the harvester device 20. As one example, the harvester device 10 may be a charging device. The harvester device 20 may include at least one of a boost converter, a buck/boost converter, a multiple input/multiple output converter, a resonant converter or any other converter with a magnetic energy storage element (e.g. inductor).

FIG. 1 shows an example arrangement of the electronic apparatus 50. Other arrangements may also be provided.

As shown in FIG. 1, the electronic device 50 may include a battery charger 52, a voltage regulator (VR) 54, a load 56 and a battery 58 (such as in a battery port). The electronic device 50 may include other components, which may or may not be part of the load 56. Additional components may include, but are not limited to, a processor, a display, a speaker (or audio output device), a wireless communication device, a camera, a memory (or storage device), a microphone, etc. Other components and/or fewer components may also be provided.

The battery charger 52 may receive an input voltage (or input power). FIG. 1 shows that the battery charger 52 may receive power from the harvester device 20 (from the alternative power source 10). The battery charger 52 may also receive power from other types of power sources.

The battery charger 52 may provide an output voltage to a voltage regulator 54, for example. The voltage regulator 54 (of the electronic device 50) may provide an output voltage to the load 56. The voltage regulator 54 may provide a regulated output voltage to the load 56.

The battery charger 52 may also (or alternatively) provide an output voltage to the battery 58 (provided at a battery port of the electronic device 50). The battery 58 may be charged by the voltage received from the battery charger 52.

The battery charger 52 may provide an output voltage to the load 56 (via a voltage regulator 54) and/or the battery 58.

FIG. 1 shows the use of an alternative power source (or alternative energy source). However, power and output voltage received from the alternative power source 10 may not be stable. In at least one embodiment, the battery charger and/or voltage regulator may also be part of the harvester device. The harvester device may then facilitate energy transfer from the alternative power source to the load(s) and/or battery as well as from battery to load. In at least one embodiment, the harvester device may be a multiple input/multiple output converter and can interface with multiple power sources and loads.

Different power sources may be used to power different types of electronic devices. However, the electronic device may not be compatible with an arbitrary power source, requiring instead an output voltage that is regulated within a certain percentage of a nominal value. Additionally, the power level of a power or energy source (or power supply) may have to be large enough to charge the battery as well as supply the load.

In a disadvantageous arrangement, a charge pump may be used to directly power a harvester (or harvester device). In the disadvantageous arrangement, the charge pump may supply significant power levels in order to maintain a voltage supply for the harvester. However, in order to supply high power levels, the charge pump may have a large size and/or require a high input voltage in order to perform a cold-start for an electronic device.

Embodiments may provide a two-stage apparatus (and/or two-step arrangement) in order to utilize available resources in a cold-start for harvesting of an alternative power source. Embodiments may include an inductive boost stage (or second stage) that may provide a significant power gain, which may help reduce current of a charge pump.

Embodiments may include a charge pump that provides voltage (or power) to a boost device. The boost device may be turned on, and power may be drawn from an alternative power source. The boost device may start operating when (or as soon as) a specific voltage is obtained by the charge pump. A harvester device may be powered by the alternative power source and an additional power from the boost device. Upon reaching a specific voltage (or specific energy), the harvester device may be turned on and may operate in a self-sustained operation. During the self-sustained operation of the harvester device, power may be provided to a load and/or a battery. The harvester device may provide, during the self-sustained operation, a proper power level to the load. The harvester device may provide, during the self-sustained operation, a proper power level to the battery.

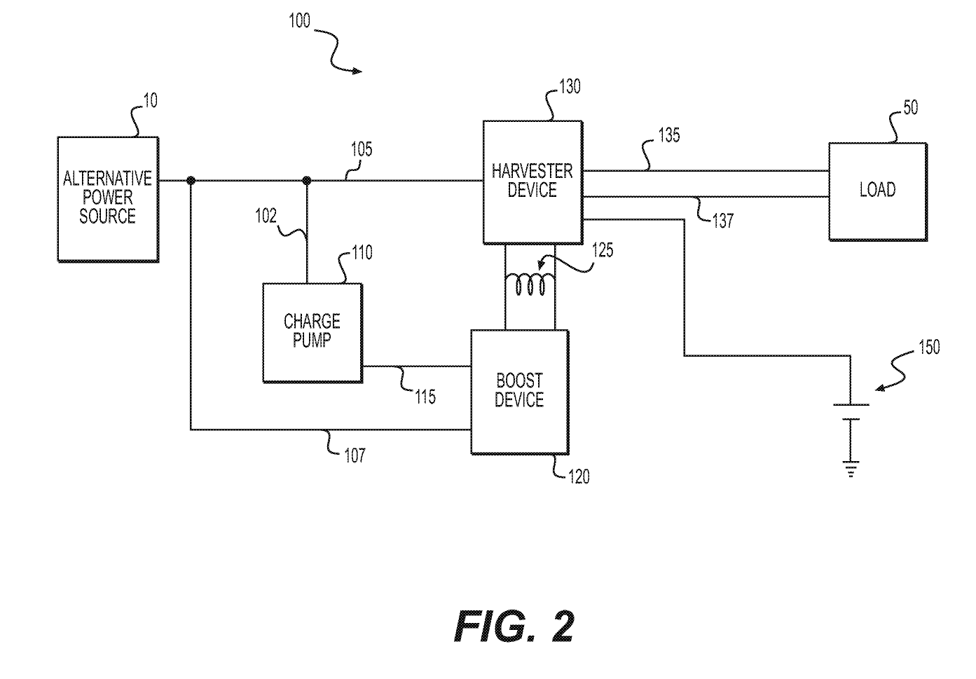

FIG. 2 shows a cold-start device for harvesting alternative power according to an example embodiment. Other embodiments and configurations may also be provided.

More specifically, FIG. 2 shows the alternative power source 10 may provide harvested energy (or alternative energy) to the load 50. FIG. 2 also shows a battery 150 that is external to the load 50. However, the battery 150 may be provided internal to the load 50. The load 50 and/or the battery 150 may receive power (and/or energy) from the harvester device 130.

FIG. 2 shows a cold-start device 100 between the alternative power source 10 and the load 50. As shown in FIG. 2, the cold-start device 100 may include a charge pump 110, a boost device 120 (or mini boost device), an inductor 125 (or inductor device) and a harvester device 130 (or harvester). The cold-start device 100 (or cold-start circuit) may include more or less components than as shown in FIG. 2.

The cold-start device 100 may operate to provide a proper power level (or voltage level) of harvested energy from the alternative power source 10 to the load 50 (and/or to a battery). Embodiments may provide a two-stage operation in order to provide the proper power level.

The first stage may include at least the charge pump 110. In at least one embodiment, the second stage may include at least the boost device. In at least one alternative embodiment, the second stage may include at least a pulse generator and a threshold detector.

Power may be provided to the load 50 based on power from the alternative power source 10 and additional power provided by the cold-start device 100. For example, power may be provided along a rail 105 from the alternative power source 10 to the harvester device 130, and power may be provided along a rail 107 to the boost device 120. Additional power may be provided via the cold-start device 100 to the harvester device 130. More specifically, additional power may be provided via the charge pump 110, the boost device 120, and the inductor 125 to the harvester device 130.

The alternative power source 10 may provide the harvested energy (or alternative energy) to the charge pump 110 (via a rail 102) and to the harvester device 130 (via the rail 105).

In a disadvantageous arrangement, the harvester device may be unable to operate in a self-sustain manner (or operation) because of insufficient energy from sources and energy storage elements (i.e., battery, supercapacitors, etc.). For example, once the harvester device has to stop, the harvester device may not be able to start itself from the alternative power source because of insufficient voltage (and all energy storages elements are depleted). Embodiments that operate with a two-stage operation, such as shown in FIG. 2, may be able to have a self-sustained operation.

The harvested energy may be accumulated prior to being provided from the harvester device 130 to the load 50 (and/or to the battery 150). For example, an additional boost to the alternative power may be provided by the charge pump 110, the boost device 120 and the inductor 125 (i.e., from the cold-start device).

In order to provide an additional boost (or additional power derived from the alternative power source), the cold-start device 100 may include two stages, namely the first stage and the second stage. The first stage may include at least the charge pump 110, and the second stage may include at least the boost device 120, for example.

Embodiments may provide the charge pump that provides voltage (or power) to the boost device. The boost device may be turned on, and power may be drawn from the alternative power source. The boost device may start operating when (or as soon as) a specific voltage is obtained by the charge pump.

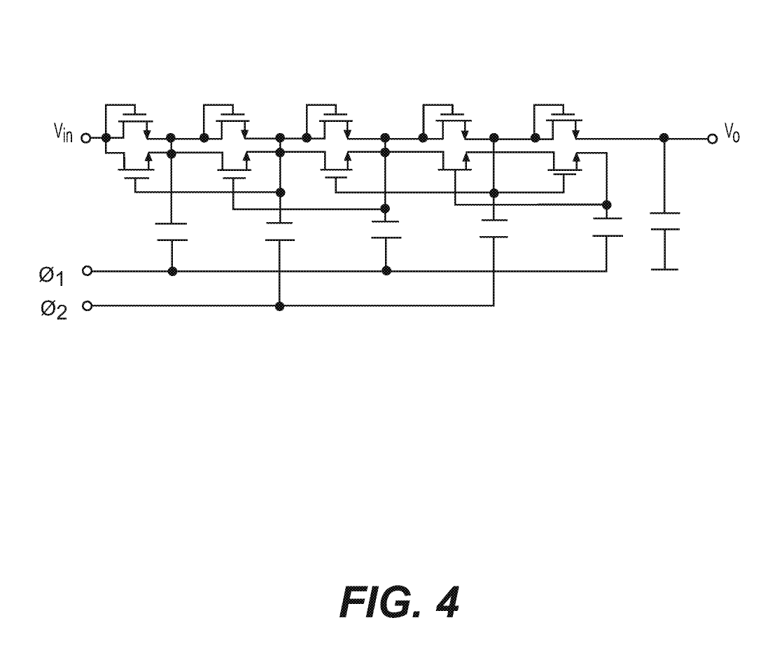

As one example, the charge pump 110 may be a Dickson charge pump or other charge pump technology. In at least one example arrangement shown in FIG. 4, the charge pump may receive a clock signal input and utilize a plurality of switch elements (e.g. metal-oxide-semiconductor field-effect transistors (MOSFET transistors)) and capacitors to provide a voltage at the output which is greater than the voltage at the input. The switch elements may be switched on and off based on the input clock signal. As an alternative, diodes may be used rather than switch elements. The charge pump may be designed to provide a certain ratio of output voltage to input voltage, and to have a certain source impedance so as to provide sufficient output voltage and power.

The charge pump 110 may be a switched capacitor boost converter device that operates directly based on received power in order to provide an output voltage. The charge pump 110 may have an input to receive the alternative power from rail 105, and the charge pump 100 may have an output to couple to an internal rail 115 (or rail). A first end of the internal rail 115 may be coupled to the output of the charge pump 110, and a second end of the internal rail 115 may be coupled to an input of the boost device 120. The rail 115 may separate the first stage from the second stage.

The second stage may include the boost device 120 which receives voltage on the internal rail 115 from the first stage. The boost device 120 may also receive the alternative power from the alternative power source 10 on the rail 107.

FIG. 2 shows the inductor 125 which may be part of the harvester device 130 or may be separate from the harvester device 130. The boost device 120 may use the inductor 125.

The boost device 120 (and the inductor 125) may be referred to as a small inductive boost power stage. The voltage on the internal rail 115 may be used to operate the small inductive boost power stage. For example, the boost device 120 (or boost circuit) may receive power from the internal rail 115 and the power may be saved/stored at the inductor 125 until a specific threshold is obtained or a certain time has expired. The boost device 120 may act as a boost to provide the additional power from the inductor to the harvester device 130.

The harvester device 130 may start providing power from the alternative power source to a rail 135 once the energy (or power) at the harvester device 130 has reached a sufficient level for the harvester device 130 to operate, and the boost device 120 may be disabled. A capacitor may be connected to the inductor 125 to stabilize the voltage. The harvester device 130 may then derive energy from the alternative power source 10 to provide a voltage on the rail 135 at a sufficient level. The harvester device may combine the alternative power from the alternative power source and the additional power from the cold-start device to at least a specific level. Upon reaching the specific level (or specific amount of energy), the harvester device may be operate at a self-sustained operation in order to provide a proper power level (or prescribed power level).

The additional power gain from the inductive boost stage (that includes the boost device 120 and the inductor 125) may allow the charge pump 110 to supply sufficiently less power than a charge pump in a disadvantageous arrangement. Thus, this embodiment may include the charge pump 110 having a reduced size as compared to disadvantageous arrangements. The charge pump 110 may provide a cold-start from a lower input voltage. The cold-start device 100 (or cold-start circuit/apparatus) may boost the harvested voltage to a sufficient level prior to being provided to the load 50 or the battery 150.

In at least one embodiment, power may be provided along a rail 137 from the harvester device 130 to the load 50. In this embodiment, the rail 135 may not be connected to the load such that the load is not coupled to the boost device 120. The load may instead be connected to the harvester device 130 through the rail 137, which may have a different voltage from the rail 135 and may be turned off if the load is not active.

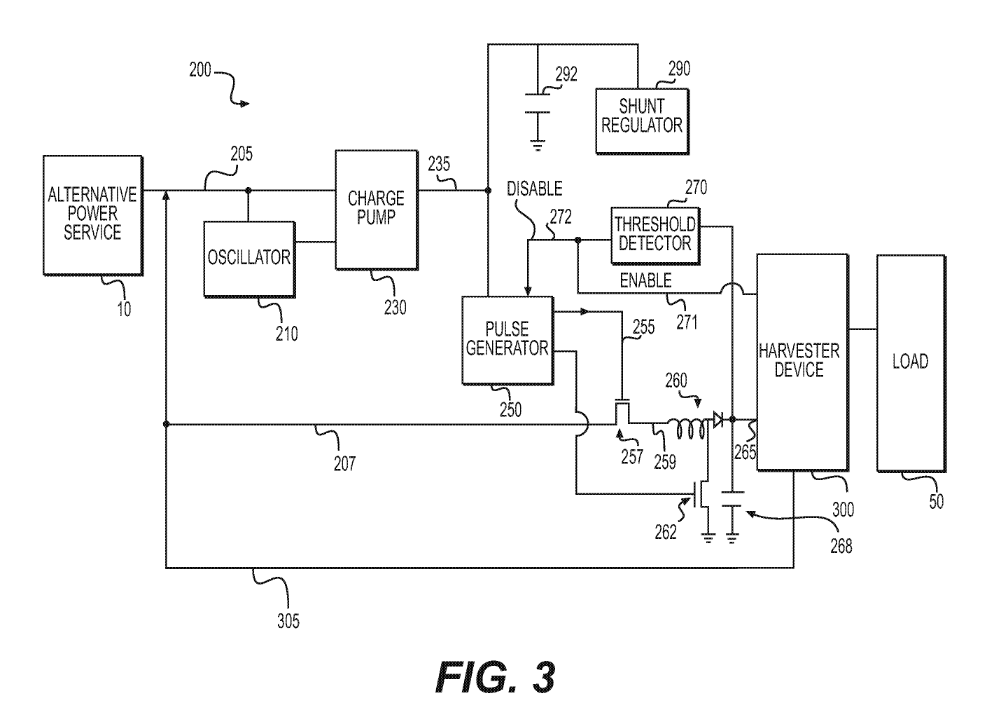

FIG. 3 shows a cold-start device for harvesting alternative power according to an example embodiment. Other embodiments and configurations may also be provided.

More specifically, FIG. 3 shows the alternative power source 10 that may provide harvested energy (or alternative energy) to a harvester device 300. The harvester device 300 may be controlled to provide an output to the load 50.

FIG. 3 shows a cold-start device 200 between the alternative power source 10 and the load 50. As shown in FIG. 3, the cold-start device 200 may include an oscillator 210, a charge pump 230 (or charge pump device), a pulse generator 250 (or pulse generator device), an inductor 260 (or inductor device), a threshold detector 270 (or threshold detector device) and a shunt regulator 290. FIG. 3 also shows that the cold-start device 200 may include other components such as logical gates, diodes, switches and capacitors. The cold-start device 100 (or cold-start circuit) may include more or less components than as shown in FIG. 3.

The cold-start device 200 may operate along with the harvester device to provide a proper power level (or voltage level) of harvested energy from the alternative power source 10 to the load 50 (and/or to a battery). Power may be provided to the load 50 based on power from the alternative power source 10 and additional power provided by the cold-start device 200. The additional power may be derived from the alternative power source.

FIG. 3 shows that alternative power may be provided to the harvester device 300 via rail 305, and additional power may be provided by the cold-start device 200 (that includes at least the charge pump 230, the pulse generator 250, the inductor 260 and the threshold detector 270). The powers may be combined at the harvester such that the harvester device may operate at a self-sustained operation.

In order to provide an additional boost, the cold-start device 200 may include two stages, namely a first stage and a second stage. In at least one embodiment, the first stage of the cold-start device 200 may include at least the charge pump 230, and the second stage of the cold-start device 200 may include at least the pulse generator 250, the inductor 260 and the threshold detector 270. Other embodiments and configurations of the first stage and the second stage of the cold-start device 200 may also be provided.

The alternative power source 10 may provide alternative power along the rail 205 to an input of the oscillator 210 and to an input of the charge pump 230. The oscillator 210 may receive the alternative power directly from the alternative power source 10. The charge pump 230 may directly receive the alternative power from the alternative power source 10.

The oscillator 210 may provide a clock signal to the charge pump 230 based on the received power from the alternative power source 10. The oscillator 210 may be programmed to provide a sufficient charge pump operation. The programming of the oscillator 210 may be based on an input voltage and an input frequency, for example.

The charge pump 230 may receive an input on the rail 205 based on the alternative power from the alternative power source 10 and the charge pump 230 may receive a clock signal at an input of the charge pump 230.

The charge pump 230 may provide an output on a rail 235. The rail 235 may be connected to an input of the pulse generator 250, and the rail 235 may be connected to the shunt regulator 290 and to a capacitor 292. The shunt regulator 290 may be provided at the output to the charge pump 230 to ensure safe operating voltage (or a sufficient level). For example, the shunt regulator 290 and the capacitor 292 may provide an operating voltage of 1.8 Volts, for example. The shunt regulator 290 and the capacitor 292 may be an optional limit device, for example.

When the charge pump 230 reaches the sufficient level (i.e., the operating voltage), then the pulse generator 250 may begin operating a small inductive boost converter power stage. This may be referred to as the second stage.

Stated differently, when the charge pump 230 reaches the sufficient level (or specific voltage), then a signal is provided to the pulse generator 250.

The inductive boost converter power stage may provide an additional boost (or additional power) that may be provided to the harvester device 300 (in addition to the power provided on the rail 305 to the harvester device 300). The harvester device 300 may combine the additional power from the second stage (or the inductive boost converter power stage) and the alternative energy from the alternative power source 10. This combined power may be sufficient in order to provide proper power (or proper power level) to the load 50 (and/or the battery 150).

The pulse generator 250 may turn on switch 257 and turn on switch 262. Since the switch 257 is turned on, then power may be provided from the alternative power source 10 via the rail 207 and thru the inductor 260, through the switch 262 and to ground. This may cause voltage to be built up in the inductor 260. In other words, power (or energy) may be stored in the inductor 260. This process may continue to store power in the inductor 260.

After a certain time, the pulse generator 250 may turn off the switch 262. A positive current may occur in the inductor 260, and the voltage may rise. Accordingly, the voltage may be provided thru a diode along rail 265 to the harvester device 300. Accordingly, the harvester device 300 may receive the additional power along the rail 265 and receive power from the alternative power source along the rail 305.

The threshold detector 270 may monitor the voltage level. An output of the threshold detector 270 may be provided along signal line 271 to enable the harvester device 300. This ENABLE signal may allow the harvester device 300 to provide the proper power level to the load 50 (based on a combination of additional power from the cold-start device 200 and the alternative power from the alternative power source 10). The threshold detector 270 may also provide a DISABLE signal to the pulse generator in order to turn off the pulse generator 250.

A switching frequency and timing of the inductive boost converter power stage may be determined based on power levels supplied by the charge pump 230. This may help avoid the charge-pump generated supply being collapsed by excessive current draw.

The inductive boost converter power stage may store an additional power. While the inductive boost converter power stage is operating, a small current pulse may be provided to a harvester supply line 259, and thru the inductor 260. This may store a charge in a decoupling capacitor 268.

When the inductive boost converter power stage reaches a prescribed voltage level, then the threshold detector 270 may provide the ENABLE signal (on signal line 271) to the harvester device 300, and may provide a cold-start DISABLE signal (on signal line 272) to the pulse generator 250.

When the pulse generator 250 receives the DISABLE signal on the signal line 272, then a signal is provided on the signal line 255 to turn on the switch 257. When the switch 257 is on, then the alternative power may be provided from the alternative power source 10 thru the switch 257, thru the inductor 260 and ultimately to the harvester device 300.

The prescribed voltage level may be determined to allow the harvester device 300 to reliably start and enter a self-sustained operation.

FIG. 4 is a circuit diagram of a charge pump according to an example arrangement. Other arrangements may also be provided.

More specifically, FIG. 4 shows one example of a charge pump being a Dickson Charge pump. As shown, the charge pump may include a plurality of MOSFETS. An input to the charge pump may correspond to an input of the charge pump 110 of FIG. 2, namely an input of the alternative power source 10 at the signal line 102. The output of the charge pump of FIG. 4 may correspond to the output of the charge pump 110 of FIG. 2, namely the output on the internal rail 115.

Alternatively, the input to the charge pump of FIG. 4 may correspond to an input of the charge pump 230 of FIG. 3, namely an input of the alternative power source 10 at the signal line 205. The output of the charge pump of FIG. 4 may correspond to the output of the charge pump 230 of FIG. 3, namely the output on the rail 235.

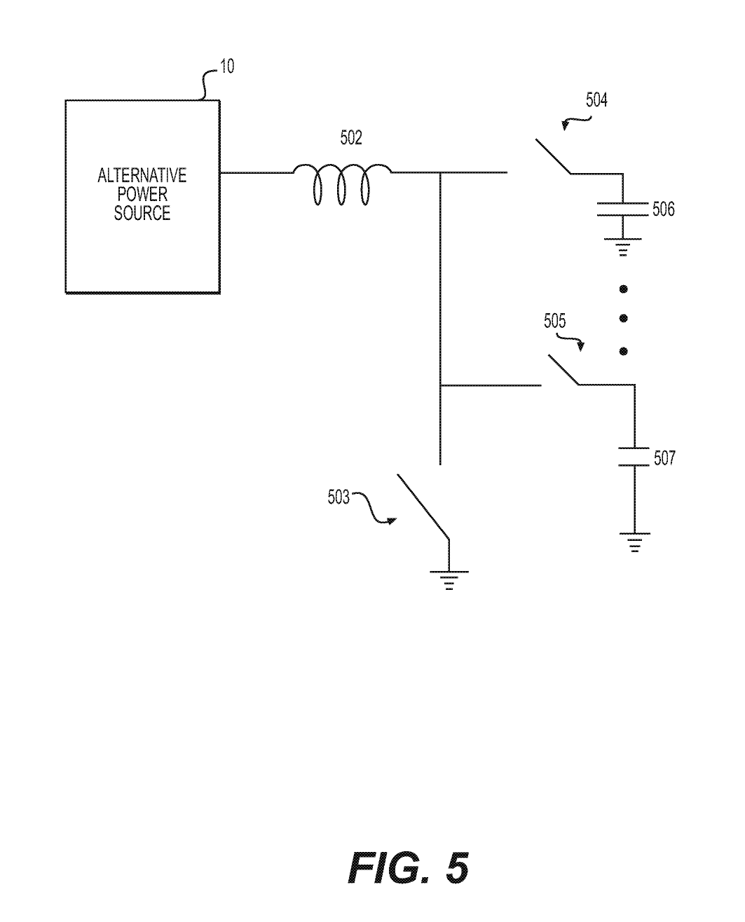

FIG. 5 is a circuit diagram of a harvester device according to an example arrangement. Other arrangements may also be provided.

In this arrangement, an inductor 502 may be used as a power transfer reservoir to switch packets of energy from the alternative power source 10 using a ground switch 503 and output load switches 504 and 505 to load energy buffer capacitors 506 and 507, respectively. The switches 503 through 505 can be timed in such a manner as to control an amount of power flow and voltages maintained on the load capacitors 506 and 507 as well as the voltage or current maintained on the alternative power source 10 to ensure efficient power transfer.

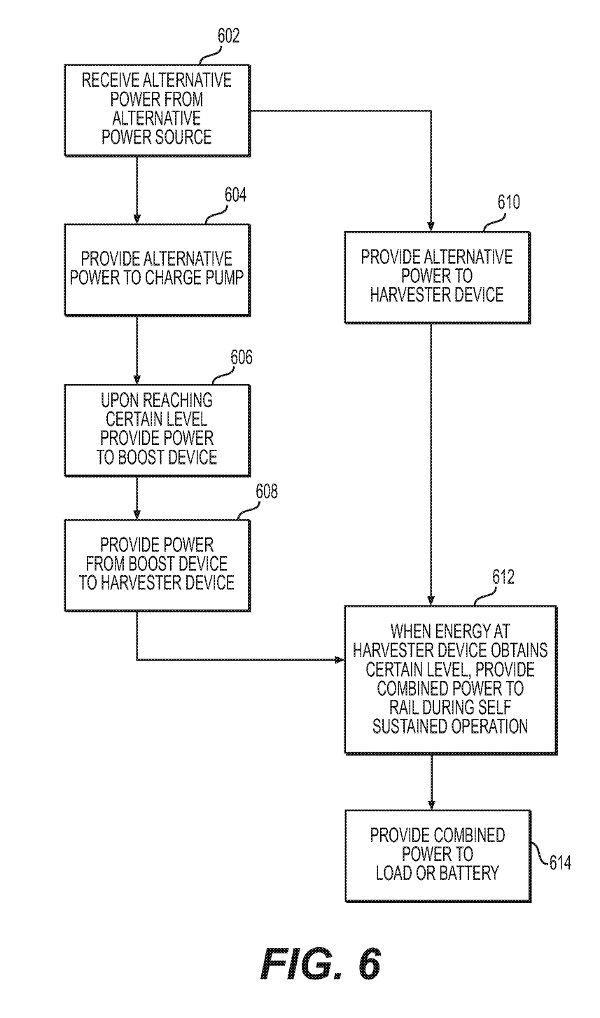

FIG. 6 is a flow chart showing a two-stage operation for harvesting energy according to an example embodiment. Other operations, orders of operations and embodiments may also be provided.

FIG. 6 shows several operations for harvesting energy as discussed above. For example, alternative power may be received from an alternative power source in operation 602. In operation 604, alternative power may be provided to the charge pump (or first stage).

Upon reaching a certain level (or specific voltage), power may be provided from the charge pump to the boost device in operation 606. The boost device may start operating when a specific voltage is obtained by the charge pump. In operation 608, power may be provided from the boost device to the harvester device.

In operation 610, alternative power may be provided to the harvester device.

When energy (or power) at the harvester device obtains a certain level in operation 612, then the harvester device may provide the combined power to a rail during a self-sustained operation.

In operation 614, the combined power may be provided to a load or to a battery.

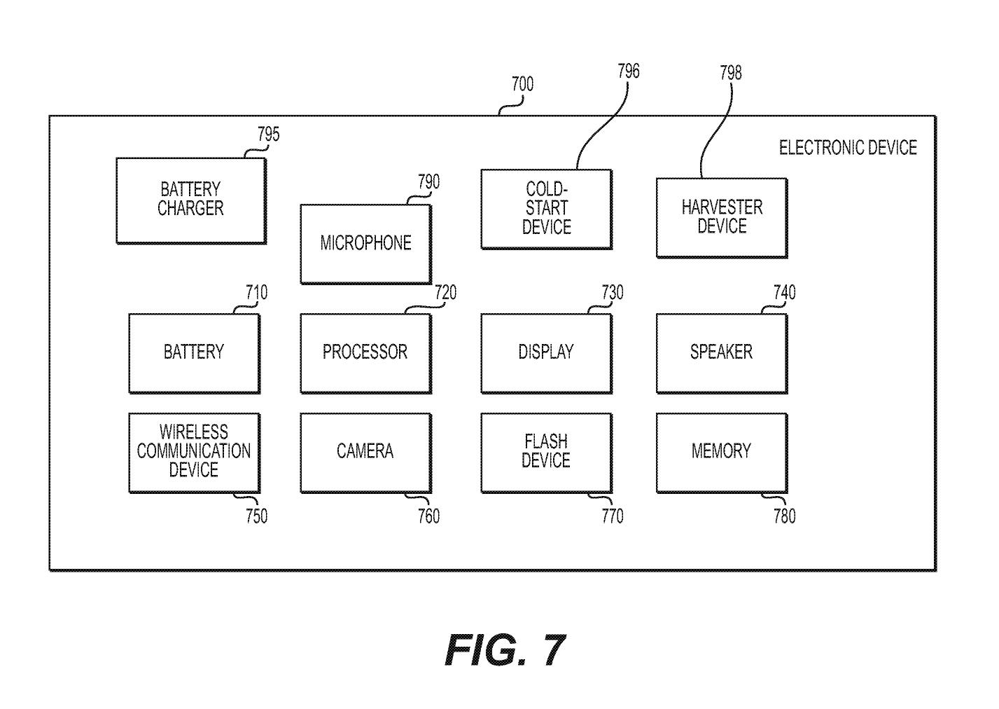

FIG. 7 shows an electronic device according to an example embodiment. Other embodiments and configurations may also be provided.

More specifically, FIG. 7 shows an electronic device 700 that may include any of the features, elements or operations discussed above. The electronic device 700 shown in FIG. 7 may correspond, in whole or in part, to the electronic device shown in FIGS. 1-3 and/or features of the other figures. More or less components may also be provided.

FIG. 7 shows that the electronic device 700 may include a battery 710, a processor 720, a display 730, a speaker 740, a wireless communication device 750, a camera 760, a flash device 770, a memory 780, a microphone 790 and a battery charger 795. FIG. 7 also shows the electronic device 200 may include a cold-start device 796 and a harvester device 798.

FIG. 7 shows the cold-start device 796 and the harvester device inside the electronic device 700. However, these components may also be provided outside the electronic device 700. The cold-start device 796 and the harvester device 798 may perform operations discussed above in order to provide a proper level of alternative power to a load or a battery.

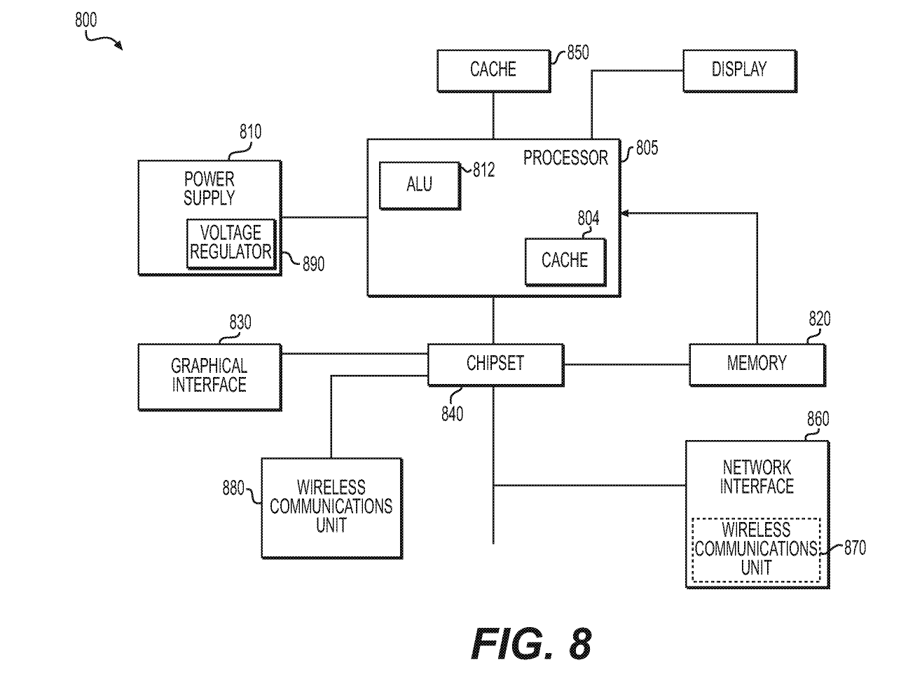

FIG. 8 shows an electronic system according to an example embodiment. Other embodiments and configurations may also be provided.

More specifically, FIG. 8 shows a system 800 that includes a processor 805, a power supply 810 (that includes a voltage regulator 890) and a memory 820, which may be a random access memory, for example. The system 800 may also include a cold-start device and a harvester device in order to receive alternative power from an alternative power source and provide a proper power level to components of the system.

The processor 805 may include an arithmetic logic unit 812 and an internal cache 804, for example. The processor 805 may perform operations by using instructions received, such as via a computer-readable medium.

The system 800 may also include a graphical interface 830, a chipset 840, a cache 850, a network interface 860 and a wireless communication unit 870, which may be incorporated within the network interface. Alternatively or additionally, the communications unit 880 may be coupled to the processor 805, and a direct connection may exist between the memory 820 and the processor 805.

The processor 805 may be a central processing unit, a microprocessor or any other type of processing or computing circuit and may be included on a chip die with all or any combination of the remaining features, or one or more of the remaining features may be electrically coupled to the microprocessor die through known connections and interfaces. Also, the connections that are shown are merely illustrative as other connections between or among the elements depicted may exist depending, for example, on chip platform, functionality, or application requirements.

In at least one embodiment, a computer-readable medium (or machine-readable medium) may store a program for controlling circuitry or logic. The program may be stored in a system memory, which for example, may be internal or external to the electronic device.

Instructions or code executed by a processor, for example, may be provided to a memory from a machine-readable medium, or an external storage device accessible via a remote connection (e.g. over a network via an antenna and/or network interface) providing access to one or more electronically-accessible media, etc. A machine-readable medium may include any mechanism that provides (i.e., stores and/or transmits) information in a form readable by a machine (e.g., a computer). For example, a machine-readable medium may include random access memory (RAM), read only memory (ROM), magnetic or optical storage medium, flash memory devices, electrical, optical, acoustical or other form of propagated signals (e.g., carrier waves, infrared signals, digital signals), etc. In alternative embodiments, hard-wired circuitry may be used in place of or in combination with the instructions or code, and thus the embodiments are not limited to any specific combination of hardware circuitry and software instructions.

The following examples pertain to further embodiments.

Example 1 is an electronic device comprising: a harvester device to receive an alternative power from an alternative power source; and a cold-start device to provide an additional power derived from the alternative power source, wherein the harvester device to further receive the additional power from the cold-start device, and to combine the alternative power and the additional power to at least a specific level.

In Example 2, the subject matter of Example 1 can optionally include the harvester device to operate in a self-sustained operation based on the combined powers.

In Example 3, the subject matter of any one of Examples 1-2 can optionally include the harvester device to provide, during the self-sustained operation, a proper power level to a load.

In Example 4, the subject matter of any one of Examples 1-2 can optionally include the harvester device to provide, during the self-sustained operation, a proper power level to a battery.

In Example 5, the subject matter of Example 1 can optionally include the cold-start device includes a first stage and a second stage.

In Example 6, the subject matter of any one of Examples 1-5 can optionally include the first stage of the cold-start device includes a charge pump.

In Example 7, the subject matter of any one of Examples 1-6 can optionally include the charge pump includes a plurality of switch elements.

In Example 8, the subject matter of any one of Examples 1-6 can optionally include the second stage of the cold-start device includes a boost device.

In Example 9, the subject matter of any one of Examples 1-8 can optionally include the boost device to start operating when a specific voltage is obtained by the charge pump.

In Example 10, the subject matter of any one of Examples 1-8 can optionally include the second stage of the cold-start device includes a pulse generator and a threshold detector.

In Example 11, the subject matter of Example 1 can optionally include a load.

In Example 12, the subject matter of any one of Examples 1-11 can optionally include the harvester device to provide the combined power to the load.

In Example 13, the subject matter of Example 1 can optionally include the alternative power source is one of a solar power source, a mechanical power source, a photovoltaic power source, a thermal power source, a radio frequency power source, a vibration power source, a biomechanical power source or a fuel cell.

In Example 14, the subject matter of Example 1 can optionally include the harvester device is a charging device.

In Example 15, the subject matter of Example 1 can optionally include the harvester device includes at least one of a boost converter, a buck/boost converter, a multiple input/multiple output converter, and a resonant converter.

In Example 16, the subject matter of Example 1 can optionally include the harvester device includes a converter with a magnetic energy storage element.

Example 17 is an electronic system comprising: an alternative power source to provide an alternative power; an electronic device to have a load; a harvester device to receive the alternative power from the alternative power source; and a cold-start device to provide an additional power derived from the alternative power source, wherein the harvester device to further receive the additional power from the cold-start device, and to combine the alternative power and the additional power to at least a specific level.

In Example 18, the subject matter of Example 17 can optionally include the harvester device to operate in a self-sustained operation based on the combined powers.

In Example 19, the subject matter of any one of Examples 17-18 can optionally include the harvester device to provide, during the self-sustained operation, a proper power level to the load.

In Example 20, the subject matter of any one of Examples 17-18 can optionally include the harvester device to provide, during the self-sustained operation, a proper power level to a battery.

In Example 21, the subject matter of Example 17 can optionally include the cold-start device includes a first stage and a second stage.

In Example 22, the subject matter of any one of Examples 17-21 can optionally include the first stage of the cold-start device includes a charge pump.

In Example 23, the subject matter of any one of Examples 17-22 can optionally include the charge pump includes a plurality of switch elements.

In Example 24, the subject matter of any one of Examples 17-22 can optionally include the second stage of the cold-start device includes a boost device.

In Example 25, the subject matter of any one of Examples 17-24 can optionally include the boost device to start operating when a specific voltage is obtained by the charge pump.

In Example 26, the subject matter of any one of Examples 17-24 can optionally include the second stage includes a pulse generator and a threshold detector.

In Example 27, the subject matter of Example 17 can optionally include the harvester device to provide the combined power to the load.

In Example 28, the subject matter of Example 17 can optionally include the alternative power source is one of a solar power source, a mechanical power source, a photovoltaic power source, a thermal power source, a radio frequency power source, a vibration power source, a biomechanical power source or a fuel cell.

In Example 29, the subject matter of Example 17 can optionally include the harvester device is a charging device.

In Example 30, the subject matter of Example 17 can optionally include the harvester device includes at least one of a boost converter, a buck/boost converter, a multiple input/multiple output converter, and a resonant converter.

In Example 31, the subject matter of Example 17 can optionally include the harvester device includes a converter with a magnetic energy storage element.

In Example 32, the subject matter of Example 17 can optionally include the electronic device to include a processor.

In Example 33, the subject matter of Example 17 can optionally include the electronic device to include a battery.

Example 34 is an electronic device comprising: harvester means for receiving an alternative power from an alternative power source; and cold-start means for providing an additional power derived from the alternative power source, wherein the harvester means for further receiving the additional power from the cold-start means, and for combining the alternative power and the additional power to at least a specific level.

In Example 35, the subject matter of Example 34 can optionally include the harvester means for operating in a self-sustained operation based on the combined powers.

In Example 36, the subject matter of any one of Examples 34-35 can optionally include the harvester means for providing, during the self-sustained operation, a proper power level to a load.

In Example 37, the subject matter of any one of Examples 34-35 can optionally include the harvester means for providing, during the self-sustained operation, a proper power level to a battery.

In Example 38, the subject matter of Example 34 can optionally include the cold-start means includes a first stage and a second stage.

In Example 39, the subject matter of any one of Examples 34-38 can optionally include the first stage of the cold-start means includes a charge pump.

In Example 40, the subject matter of any one of Examples 34-39 can optionally include the charge pump includes a plurality of switch elements.

In Example 41, the subject matter of any one of Examples 34-40 can optionally include the second stage of the cold-start device includes a boost device.

In Example 42, the subject matter of any one of Examples 34-41 can optionally include the boost device to start operating when a specific voltage is obtained by the charge pump.

In Example 43, the subject matter of any one of Examples 34-41 can optionally include the second stage of the cold-start device includes a pulse generator and a threshold detector.

In Example 44, the subject matter of Example 34 can optionally include a load.

In Example 45, the subject matter of any one of Examples 34-44 can optionally include the harvester means for providing the combined power to the load.

In Example 46, the subject matter of Example 34 can optionally include the alternative power source is one of a solar power source, a mechanical power source, a photovoltaic power source, a thermal power source, a radio frequency power source, a vibration power source, a biomechanical power source or a fuel cell.

In Example 47, the subject matter of Example 34 can optionally include the harvester means is a charging device.

In Example 48, the subject matter of Example 34 can optionally include the harvester means includes at least one of a boost converter, a buck/boost converter, a multiple input/multiple output converter, and a resonant converter.

In Example 49, the subject matter of Example 34 can optionally include the harvester means includes a converter with a magnetic energy storage element.

Example 50 is a method of powering an electronic device comprising: receiving alternative power from an alternative power source; providing, from a cold-start device, an additional power derived from the alternative power source; receiving, at a harvester device, the alternative power from the alternative power source; receiving, at the harvester device, the additional power from the cold-start device; and combining the alternative power and the additional power to at least a specific level.

In Example 51, the subject matter of Example 50 can optionally include operating the harvester device in a self-sustained operation based on the combined power.

In Example 52, the subject matter of any one of Examples 50-51 can optionally include providing, during the self-sustained operation of the harvester device, a proper power level to a load.

In Example 53, the subject matter of any one of Examples 50-51 can optionally include providing, during the self-sustained operation of the harvester device, a proper power level to a battery.

In Example 54, the subject matter of Example 50 can optionally include the cold-start device includes a first stage and a second stage.

In Example 55, the subject matter of any one of Examples 50-54 can optionally include the first stage of the cold-start device includes a charge pump.

In Example 56, the subject matter of any one of Examples 50-55 can optionally include the charge pump includes a plurality of switch elements.

In Example 57, the subject matter of any one of Examples 50-55 can optionally include the second stage of the cold-start device includes a boost device.

In Example 58, the subject matter of any one of Examples 50-57 can optionally include providing the additional power includes starting operating of the boost device when a specific voltage is obtained by the charge pump.

In Example 59, the subject matter of any one of Examples 50-57 can optionally include the second stage of the cold-start device includes a pulse generator and a threshold detector.

In Example 60, the subject matter of Example 50 can optionally include a load.

In Example 61, the subject matter of any one of Examples 50-60 can optionally include providing, by the harvester device, the combined power to the load.

In Example 62, the subject matter of Example 50 can optionally include the alternative power source is one of a solar power source, a mechanical power source, a photovoltaic power source, a thermal power source, a radio frequency power source, a vibration power source, a biomechanical power source or a fuel cell.

In Example 63, the subject matter of Example 50 can optionally include the harvester device is a charging device.

In Example 64, the subject matter of Example 50 can optionally include the harvester device includes at least one of a boost converter, a buck/boost converter, a multiple input/multiple output converter, and a resonant converter.

In Example 65, the subject matter of Example 50 can optionally include the harvester device includes a converter with a magnetic energy storage element.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An electronic device comprising:
a harvester device to receive an alternative power from an alternative power source; and
a cold-start device to provide an additional power derived from the alternative power source, wherein the harvester device to further receive the additional power from the cold-start device, and to combine the alternative power and the additional power to at least a specific level.

2. The electronic device of claim 1, wherein the harvester device to operate in a self-sustained operation based on the combined powers.

3. The electronic device of claim 2, wherein the harvester device to provide, during the self-sustained operation, a proper power level to a load.

4. The electronic device of claim 2, wherein the harvester device to provide, during the self-sustained operation, a proper power level to a battery.

5. The electronic device of claim 1, wherein the cold-start device includes a first stage and a second stage, and the first stage of the cold-start device includes a charge pump.

6. The electronic device of claim 5, wherein the second stage of the cold-start device includes a boost device.

7. The electronic device of claim 6, wherein the boost device to start operating when a specific voltage is obtained by the charge pump.

8. The electronic device of claim 1, wherein the alternative power source is one of a solar power source, a mechanical power source, a photovoltaic power source, a thermal power source, a radio frequency power source, a vibration power source, a biomechanical power source or a fuel cell.

9. An electronic system comprising:
an alternative power source to provide an alternative power;
an electronic device to have a load;
a harvester device to receive the alternative power from the alternative power source; and
a cold-start device to provide an additional power derived from the alternative power source, wherein the harvester device to further receive the additional power from the cold-start device, and to combine the alternative power and the additional power to at least a specific level.

10. The electronic system of claim 9, wherein the harvester device to operate in a self-sustained operation based on the combined powers.

11. The electronic system of claim 10, wherein the harvester device to provide, during the self-sustained operation, a proper power level to the load.

12. The electronic system of claim 10, wherein the harvester device to provide, during the self-sustained operation, a proper power level to a battery.

13. The electronic system of claim 12, wherein the cold-start device includes a first stage and a second stage, and the first stage of the cold-start device includes a charge pump.

14. The electronic system of claim 13, wherein the second stage of the cold-start device includes a boost device.

15. The electronic system of claim 14, wherein the boost device to start operating when a specific voltage is obtained by the charge pump.

16. A method of powering an electronic device comprising:
receiving alternative power from an alternative power source;
providing, from a cold-start device, an additional power derived from the alternative power source;
receiving, at a harvester device, the alternative power from the alternative power source;
receiving, at the harvester device, the additional power from the cold-start device; and
combining the alternative power and the additional power to at least a specific level.

17. The method of claim 16, comprising operating the harvester device in a self-sustained operation based on the combined power.

18. The method of claim 17, comprising providing, during the self-sustained operation of the harvester device, a proper power level to a load.

19. The method of claim 17, comprising providing, during the self-sustained operation of the harvester device, a proper power level to a battery.

20. The method of claim 16, comprising providing, by the harvester device, the combined power to a load.
